(19) United States
(12) Patent Application Publication
(10) Pub. No.: US 2010/0186175 A1
(43) Pub. Date: Jul. 29, 2010

(54) E.e.z.z. ultimate survival tool

(76) Inventor: Brad Alan Watson, Monahans, TX (US)

Correspondence Address: Brad A. Watson, 2901 South Helen Ave., Monahans, TX, 79756, US

(21) Appl. No.: 12/322,057

(22) Filed: Jan. 29, 2009

(51) Int. Cl. B25F 1/04

(52) U.S. Cl. 7/158

(57) ABSTRACT

One embodiment of a survival tool that's ten blades fold up on one end, and include a wood saw, metal saw,butcher knife, phillips screw driver, flat head screw driver, straight pick, triangular metal file, razor knife, round metal file, and shraded edge butcher knife, with all blades 7″ in length. The other end of the one embodiment to contain a butane lighter that is refillable and a storage compartment that includes the following items being plastic baggie of fish hooks and string, plastic baggie of 10′ of rolled galvinized wire, plastic baggie of three different sized needles and thread, a magnifying glass, a signaling mirror, tweezers, wire brush, razor blades, can and bottle opener, and a small tube of super glue. This end of tool also has a flash light and compass that can fold over to shine on other end of tool when using blade tools. This end also has a rubber coated strong handle to make ease of two handed use of tool when using different blades. Tool also has rubber coated sleeves on both sides of blade end in which hold a pair of pliers and a pair of scissors with snap straps to hold secure. Tool comes with a leather holding holster with belt strap and has a signaling flare in built in sleeve on side of holster for easy reach and use.

### CROSS REFERENCED TO RELATED APPLICATIONS

None

### FEDERALLY SPONSORED RESEARCH

Not Applicable

### SEQUENCE LISTING OR PROGRAM

Not Applicable

### BACKGROUND

1. Field of Invention

This invention relates to survival needs in extreme situations as well as for pleasure,and can be used for hunting, wartime situations, as well as simply a handy tool to have for anyone as this one bodied tool has many different tools in one.

2. Prior Art

Survival tools up to the present date have but few inventions that make surviving in extreme situations an easy thing to do. The Swiss Army Knife is but one of the best, as it has many different fold out blades with different tools such as screw driver, and can opener blades, however this tool is very small and its blades are also small for survival needs.

When a person is put in a survival situation there are so many different tools and equipment one would need, that it would require a large back pack and be very bulky to carry, which is not what one needs in a survival situation, as one needs to be as light as possible and as least bulky as possible, so that one can maneuver and move about as quickly and as least tiring so that ones energy can be saved. In survival situations one would need wood and metal saws, large knifes, compass, fishing gear, fire starting equipment, as well as many other tools as you never know what kinds of terrain or weather environments one may encounter. Most all survival tools for todays use are seperate pieces of equipment that are very bulky and are therfor not appropriate for true survival or wartime in the field use.

### SUMMARY

In accordance with one embodiment a hand held tool comprising of a fold out blade end comprising of a metal saw, wood saw, butcher knife, phillips screw driver, flat screw driver, triangular metal file, round metal file, razor knife, pick, and shraded edge butcher knife, with lock and unlock control arm. The rest of the survival tool comprising of a refillable butane lighter, flash light that can fold to shine at tool end or handle end, compass, and handle for two hand use, and a storage compartment with the following contents: a wire brush, magnifying glass, signaling mirror, can opener, fish hooks and line, tweezers, razor blades, needle and thread, wire, and tube of super glue. This tool also has holsters for scissors and pliers, and a holster for tool that can be worn on belt that also has a signaling flare in sleeve of holster.

This one embodiment tool has everything a person would need to help survive in any type field or war field situation and increases chances of surviving an extreme survival situation.

### DRAWINGS—FIGURES

FIG. 1 shows an overall view of survival tool with blade end in fold up or non use position.

FIG. 2 shows overall survival tool with flashlight folded over to shine on blade end and storage compartment in open position.

FIG. 3 shows just blade end of survival tool with all blades visible.

FIG. 4 shows the holster for survival tool

### DRAWINGS—REFERENCE NUMERALS

20 Handle for two handed blade use
22 Flash light that folds for both end shine
23 velcro to hold flash light when folded over to blade shine
24 Battery compartment for 3 AA batteries
26 compass
28 folding bracketts for flash light
30 Pliers
32 Pliers sleeve
34 10 different blades that fold out for use
35 Blade hold bar
36 Velcro strap for flashlight hold
37 snap for flash light when at handle end use
38 screws that hold handle on to tool
39 Storage compartment underneath flash light
40 Butane lighter spickett
41 Flash light on-off switch
42 Butane lighter ignite switch
44 Butane refill spout
46 Scissors
47 Scissors snap strap
48 Blade release and hold control arm
50 Scissors sleeve
52 Storage compartment lid finger slot
54 Storage compartment lid
56 Storage compartment
58 Pliers
60 Rubber grip pad
62 Fish hooks and line in plastic baggie
64 Galvanized wire 10′ long rolled up in plastic baggie
66 Needles and thread in plastic baggie
68 Scissors
70 Magnifying glass
72 Signaling mirror
74 Tweezers
76 Wire brush
78 Razor blades
80 Can opener and bottle opener
82 Tube of super glue
83 blade hole build up
84 Metal saw blade
86 Wood saw blade
88 Butcher knife blade
90 Phillips screw driver blade
92 Flat screw driver blade
94 Pick
96 Triangular metal file
98 Razor knife
100 Round Metal file
102 Scraded edge butcher knife
104 Survival tool holding strap and snap
106 Leather strap
108 Snap
110 Leather Holster
112 Lighter spickett cutout
114 Belt sleeve
116 Signal flare
118 Signal flare sleeve or holder

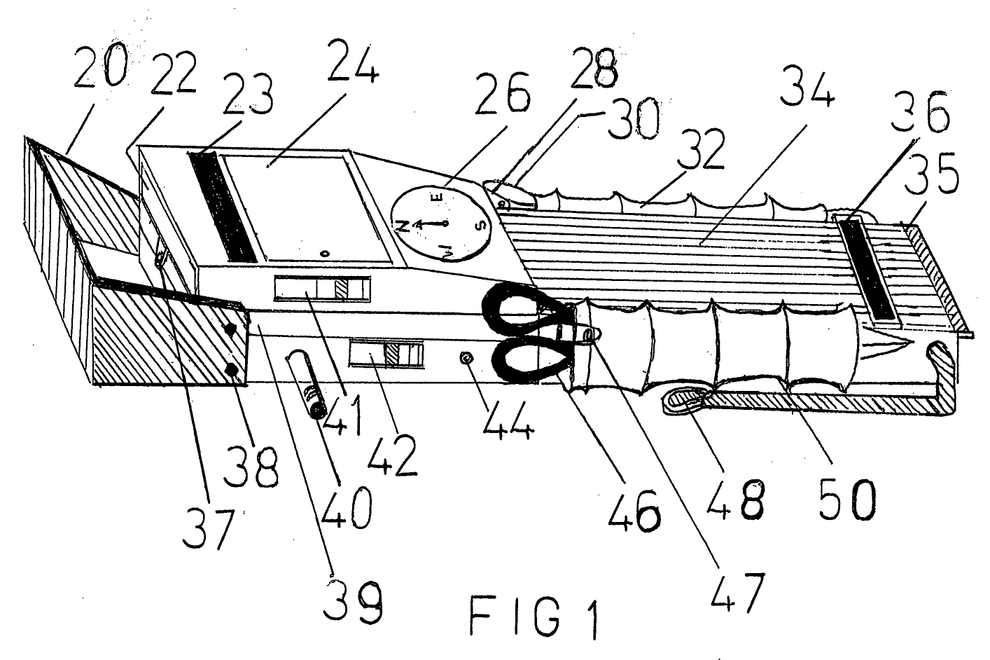

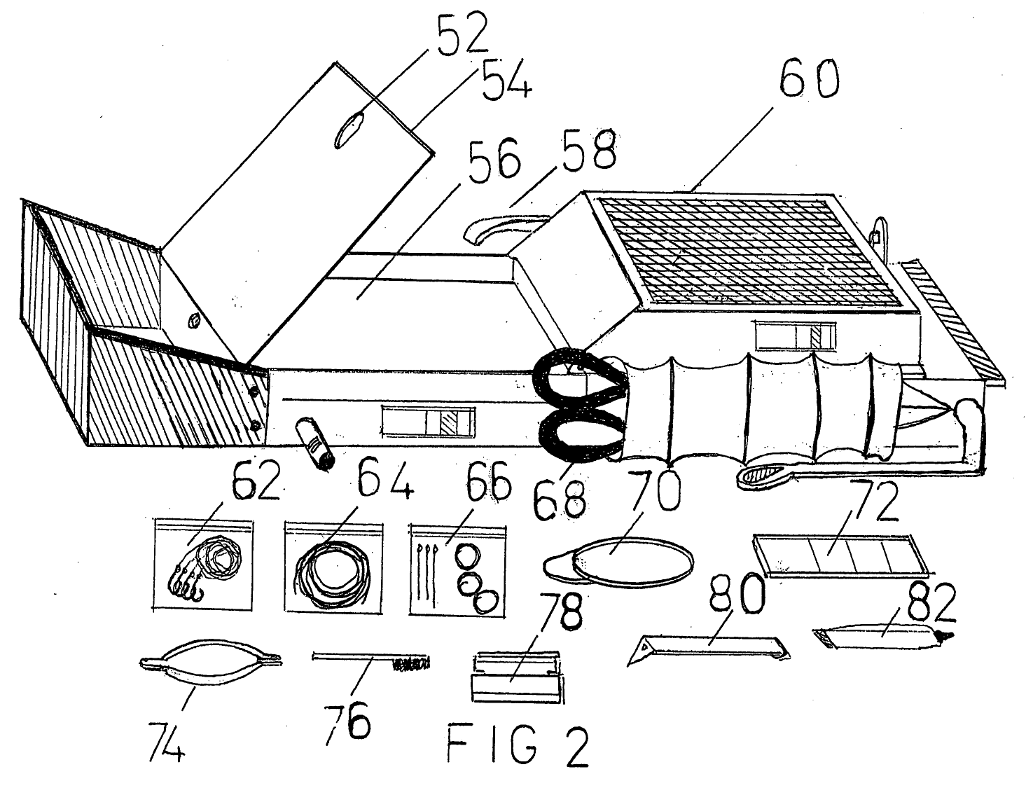

### DETAILED DESCRIPTION—FIGS. 1, 2, & 3 PREFERRED EMBODIMENT

One embodiment of the survival tool is illustrated in FIGS. 1,2, & 3 starting with the ⅛″ thick metal handle coated with rubber for softer grip that makes use of tool much easier. FIG. 1, 22 shows the flash light head or lens in carry mode or holster position. 23 shows the velcro strap glued onto flashlight that is used as a means of holding flashlight secure when flashlight is folded over to shine on blade end of survival tool. Num 24 shows the battery opening compartment, which holds three AA batteries, and is lid or cover is held down with small phillips screw. Num 26 shows the compass which is just below flashlight and is only visible while in holster use position. Num 28 shows the swiveling brackett of flashlight which allows flashlight to fold over to shine on blade end. Num 30 shows the pliers which are in a sleeve located on left side of blade body which also have a snap strap to secure them against tool. Num 32 shows the sleeve with cushioned rubber finger grip built around sleeve to make a soft firm grip for user when using any of the blade tools. Num 34 shows the 10 different blades the survival tool comes with. Num 36 shows the velcro strap glued onto bar located just above blades for flashlight to be secured to when flashlight used to shine on blade end of tool.

Num 35 shows the tool bump bar which holds blades in working position when blade in use. Num 37 shows the snap strap that holds the flashlight in place when in holster position of use. Num 38 shows the two metal screws that secure handle to tool. Num 39 shows the storage compartment area that can be opened only when flashlight has been folded over to shine on blade end of tool. Num 40 shows the butane lighter ignite tube while 41 shows the flashlight on-off switch and 42 showing lighter ignite switch. Num 44 shows the butane lighter refill inlet. Num 46 shows the scissors inside its holding sleeve 50 with its securing snap strap 47. Num 48 shows the blade loosening and tightening control arm.

FIG. 2, Num 52 shows the storage compartment finger opening on storage compartment lid 54, while 56 shows the inside of storage compartment which holds all items in 62 thru 82. Num 58 shows the pliers referred to in num 30. Num 60 shows the cushioned rubber pad glued onto backside of flashlight so when blades are being used user has a cushioned grip for hand. All the remaining items except 68 the scissors are to be kept in the storage compartment of survival tool which contain Num 62 Plastic baggie containing 5 fish hooks and fish line. 64 plastic baggie containing 10′ galvanized wire. Num 66 3 different sized needles and thread. num 70 a magnifying glass Num 72 shows a signaling mirror and 74 shows tweezers and 76 a small wire brush and 78 two razor blades. Num 80 shows the can and bottle opener and 82 the small tube of super glue.

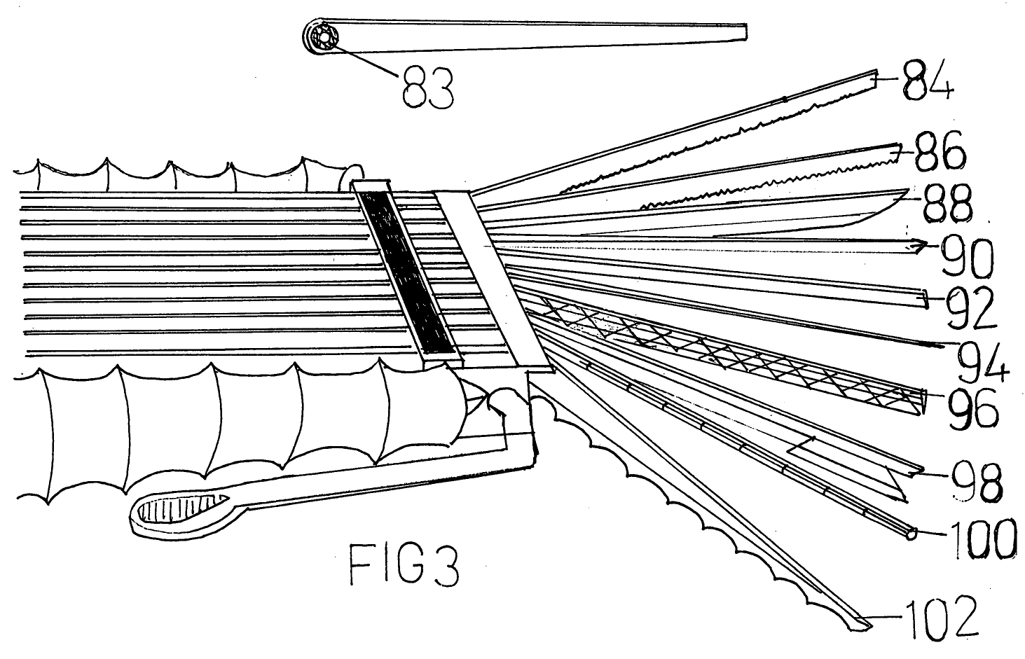

FIG. 3 Num 83 shows the blade shape with all blades being 7″ long and ⅛″ width and made of tungsten steel. blades also have hole that is raised 1/16″ with gripping grooves around holes so that when blades are in use they will be more secure shown 83 Num 84 shows the wood saw blade and 86 shows the metal sawing blade. Num 88 shows the butcher knife blade and 90 shows the phillips screw driver blade and 92 the flat head screw driver blade. Num 94 shows the straight pick blade and 96 shows the triangular metal file blade and 98 shows the razor knife blade. Num 100 shows the round metal file blade and 102 the schraded edge butcher knife blade.

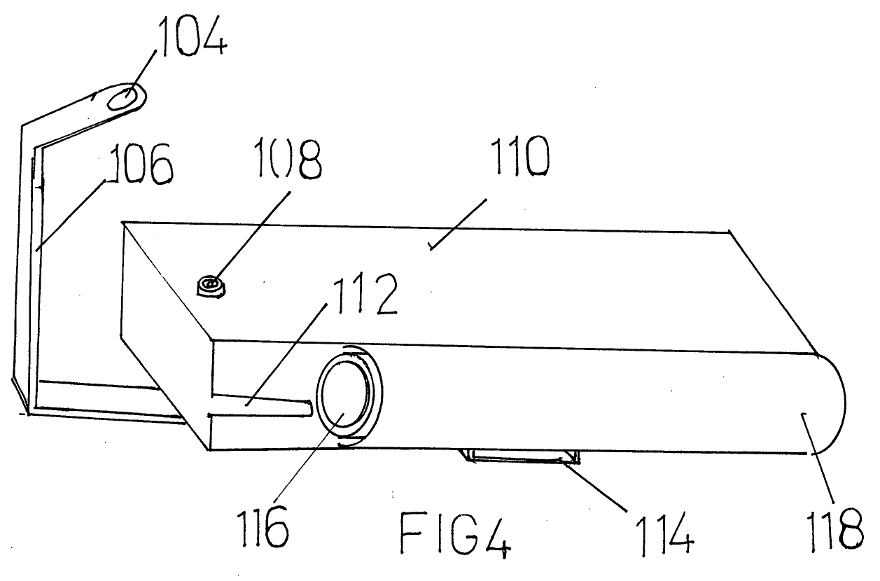

FIG. 4 shows the survival tool holster with 104 showing the snap and 106 the leather strap for securing tool in holster. Num 108 refers to the snap on holster to secure strap and 110 refers to the leather holster itself. Num 112 refers to the cut-out for butane lighter ignite spout and 114 to the belt harness where belt would run through and 116 shows the signaling flare in its seperate sleeve holder 118.

### Operation

Take survival tool FIGS. 1,2, & 3 out of it's holster or carrying sheath and then pu;; up on blade control arm to release all the blades Num 84,86,88,90,92,94,96,98,100, & 102, letting them dangle down, then raise up the blade chosen for use, and fold the other blades back under and push downward on control arm to tighten blade in use against blade work rest bar. Then you can use right or left hand on handle and other hand on blade finger sheaths to make effective two hand use of the tool. Flashlight can be folded over to shine on work area while using blades, and then folded back over when used as flashlight and compass for navigation or direction finding.

Use of the butane lighter is also simple just put ignite spickett next to what you want to light and push electric start switch. When you need something from the storage compartment simply fold flashlight over to shine on blade end on velcro hold straps then open storage compartment by finger hole to retrieve fish hooks, wire or whatever you need from survival equipment stored in storage compartment.

When finished with tool replace back in holder or carrying sheath and you are ready for travel, and if emergency signaling flare is needed, it is readily available on outside of carrying sheath or holster. All blades can be replaced when needed, and butane lighter is refillable.

### Advantages

From the description above, a number of advantages should become clear to the reader of some of my embodiments.

(a) That the ten different blades offer user the tools needed to cut wood, metal, meat, bones, or other as well as file metal or other hard surfaces in any shapes from round to flat. Blades also have razor knife for fine cutting and a pick that could be used for breaking up ice or using in other ways as necessary.

(b) That the handle on one end and finger rubber coated sheaths on the other end make two handed use of the tool more effective for cutting down tree's, or sawing logs or whatever as more pressure is able to be applied by using two hands.

(c) It should be clear that the flashlight being able to fold over to both sides of use make using blade end much better for night or low light use.

(d) All the different items that are in the storage compartment will come in very useful and could be life saving in a survival situation as you could catch fish to eat or signal a plane or helicopter with the signaling mirror, if you had already used your signaling flare, and you could start a fire with the magnifying glass if your lighter was out of butane or failed to work. Super glue could also sew up large cuts in skin temporarily or until you can reach doctor and could save loss of blood.

(e) The survival tool being so complete and having so many different tool on one embodiment make this a tool for many uses and is why it is called the ultimate survival tool,

(f) The compass makes finding your way out of a survival situation much easier and safer as when you are in that kind of situation you need to pick one direction and stay with it and this will help you not get lost from the direction you have chosen.

(g) The signaling flare being located on outside of holster makes it easy and quick to retrieve and use which is critical in a survival situation.

(h) The holster being made out of leather is very durable as well as comfortable against leg when worn on belt and has snap on strap to hold securely.

### Conclusion, Ramifications, and Scope

Thus the reader will see that at least one embodiment of the survival tool provides for a much more liklyhood of survival in an extreme survival situation, as well as provides as a very useful tool for just about anyone to have in their car's or trucks, as well as for all avid hunters and fisherman to carry with them on their outdoor adventures, and is very useful to soldiers who may be put out into hostile fields to live for days or weeks while pursuing their enemies or performing search and rescue maneuvers.

While my above description contains many specifications these should not be construed as limitations on the scope of the invention, but rather as an exemplification of one or more of the preferred embodiment thereof. Many other variations are possible. Applicant has suggested that blades are to be around 7″ in length and around ⅛″ thick and made of tungsten steel, however blade lengths and dimensions could surely variable and their material could also vary to hardened steel to stainless steel. Applicants measures of the overall tool with blades in carry or holster position is that it not be more than 13″ in overall length and not more than 4″ in width, and not more than 2½″ thick as applicant feels in survival situations tool should not be too bulky or heavy. These are only applicants suggestions on size ultimate survival tool, and a tool made for other specific uses using applicants same design could surly be done but applicant feels that would be a violation of his patent.

Applicants invention is made with survival upmost in his design, however this being such a useful tool to so many other people not in survival situations, taking some of the items included from this tool or deleting some of it's blades or tools to make a simple use tool would be infringement on applicants invention on making a survival tool, and would surly be infringement on applicants basic design of tool.

I claim:

1. A tool made for survival use in the field for hunters, fishermen or outdoor people as well as for the soldier in the battlefield.

2. The tool of claim 1 to have a fold out blade end that comprises of a wood cutting saw blade

3. The tool of claim 1 to have a fold out blade end that comprises of a metal cutting saw blade

4. The tool of claim 1 to have a fold out blade end that comprises of a butcher knife blade

5. The tool of claim 1 to have a fold out blade end that comprises of a phillips screw driver blade

6. The tool of claim 1 to have a fold out blade end that comprises of a flat head screw driver blade

7. The tool of claim 1 to have a fold out blade end that comprises of a straight pick blade

8. The tool of claim 1 to have a fold out blade end that comprises of a triangular metal file blade

9. The tool of claim 1 to have a fold out blade end that comprises of a razor knife blade

10. The tool of claim 1 to have a fold out blade end that comprises of a round metal file blade

11. The tool of claim 1 to have a fold out blade end that comprises of a schraded edge butcher knife blade

12. The tool of claim 1 to also have a Handle end on the tool that makes two handed use of the tool possible while using blade end of tool.

13. The tool of claim 1 to also have a flashlight and compass that can fold over to either end to shine on work or use end of tool.

14. The tool of claim 1 to also have a storage compartment underneath flashlight that comprises of the following items such as fish hooks and line, galvanized wire, needles and thread, magnifying glass, signaling mirror, tweezers, wire brush, razor blades, can and bottle opener, and tube of super glue.

15. The tool of claim 1 to also comprise of a rubber coated finger gripping sheath with snap strap to hold a pair of scissors, on one side of blade end.

16. The tool of claim 1 to also comprise of a rubber coated finger gripping sheath with snap and strap to hold a pair of pliers.

17. The tool of claim 1 to also come with it's carrying holster with belt strap that is made of leather and has a signaling flare in sleeve on one side for easy reach and use.
